(19) United States
(12) Patent Application Publication
(10) Pub. No.: US 2011/0255828 A1
(43) Pub. Date: Oct. 20, 2011

(54) SAPPHIRE-BASED DELIVERY TIP FOR OPTIC FIBER

(75) Inventor: Venkatapuram S. Sudarshanam, Chesterbrook, PA (US)

(73) Assignee: AMS RESEARCH CORPORATION, Minnetonka, MN (US)

(21) Appl. No.: 13/141,644

(22) PCT Filed: Dec. 22, 2009
(86) PCT No.: PCT/US09/69162

§ 371 Date: Jun. 22, 2011

Related U.S. Application Data
(60) Provisional application No. 61/139,804, filed on Dec. 22, 2008.

(51) Int. Cl. G02B 6/26; C03B 37/01; B32B 38/14; B32B 38/18; B32B 38/10

(52) U.S. Cl. 385/31; 156/294; 156/154; 156/278; 156/277; 65/406; 65/407

(57) ABSTRACT

An article of manufacture is provided that includes an optic fiber comprising a core and a cladding surrounding the core and a sapphire tube bonded to the optic fiber. A total internal reflection surface is positioned such that light guided within the core of the optic fiber reflects off the total internal reflection surface and through the sapphire tube. In other embodiments, a sapphire rod having a total internal reflection surface is fused to an optic fiber comprising a core and a cladding surrounding the core. A glass coating is present on the exterior surface of portions of the sapphire rod such that the glass coating defines an opening that exposes portions of the sapphire rod where light exits the sapphire rod after reflecting off the total internal reflection surface.

### BACKGROUND

Optic fibers guide laser light from a first end of the optic fiber to a second end of the optic fiber. The light is maintained within the optic fiber due to total internal reflection that occurs at a boundary between a central core of the optic fiber and a surrounding cladding. This total internal reflection is caused by a difference in the index of refraction of the core relative to the cladding.

In some optic fibers, the laser light is emitted from the end of the optic fiber. In other optic fibers, the end of the optic fiber is machined so that the laser light is emitted from a side surface of the tip of the optic fiber.

When high-powered laser light exits an optic fiber and strikes a nearby target, the resulting heat can damage the glass of the optic fiber. In particular, the heat can cause devitrification along the surface of the glass by driving out certain components of the glass and forming a new crystalline structure in the glass. Such devitrification destroys the glossy appearance of the glass resulting in a whitish appearance that is not as transparent as undamaged glass. For many optic fibers, devitrification is one of the main damage mechanisms affecting the reliability and working life of the optic fiber.

The discussion above is merely provided for general background information and is not intended to be used as an aid in determining the scope of the claimed subject matter.

### SUMMARY

An article of manufacture is provided that includes an optic fiber comprising a core and a cladding surrounding the core and a sapphire tube bonded to the optic fiber. A total internal reflection surface is positioned such that light guided within the core of the optic fiber reflects off the total internal reflection surface and through the sapphire tube.

In other embodiments, an article of manufacture is provided that includes an optic fiber comprising a core and a cladding surrounding the core and a sapphire rod, fused to the core of the optic fiber and having a total internal reflection surface. A glass coating is present on the exterior surface of portions of the sapphire rod such that the glass coating defines an opening that exposes portions of the sapphire rod where light exits the sapphire rod after reflecting off the total internal reflection surface.

A method is provided that involves inserting an optic fiber into an interior of a sapphire tube and bonding the optic fiber to the sapphire tube to form a delivery tip, wherein the delivery tip comprises a total internal reflection surface such that light guided by the optic fiber reflects off the total internal reflection surface and out through the sapphire tube.

A method is also provided that involves forming a total internal reflection surface on a sapphire rod and forming a glass layer on the exterior of the sapphire rod such that an opening in the glass layer is present. The sapphire rod is bonded to an optic fiber.

A further method is provided that involves filling a sapphire tube with molten glass and cooling the glass-filled sapphire tube. A total internal reflection surface is formed on the glass-filled sapphire tube and the glass-filled sapphire tube is bonded to an optic fiber.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a laser system.

FIG. 2 is a cross-sectional side view of a side-firing optic fiber tip with a sapphire rod.

FIG. 3 is a cross-sectional side view of a side-firing optic fiber tip with a sapphire rod and an optic fiber end.

FIG. 4 is a method of forming the optic fiber tips of FIGS. 2 and 3.

FIG. 5 is a cross-sectional side view of a side-firing optic fiber tip with a sapphire casing attached with an interference fit.

FIG. 6 is a method of forming the optic fiber tip of FIG. 5.

FIG. 7 is a cross-sectional side view of a side-firing optic fiber tip with a coreless rod and a sapphire casing attached with an interference fit.

FIG. 8 is a method of forming the optic fiber tip of FIG. 7.

FIG. 9 is a cross-sectional side view of a side-firing optic fiber tip with a sapphire casing attached with solder.

FIG. 10 is a method of forming the optic fiber tip of FIG. 9.

FIG. 11 is a cross-sectional side view of a side-firing optic fiber tip with a coreless rod and a sapphire casing attached with solder.

FIG. 12 is a method of forming the optic fiber tip of FIG. 11.

FIG. 13 is a cross-sectional side view of a side-firing optic fiber tip with a sapphire tube attached with an interference fit and a lower index glass tip.

FIG. 14 is a method of forming the optic fiber tip of FIG. 13.

FIG. 15 is a cross-sectional side view of a side-firing optic fiber tip with a sapphire tube attached with solder and a lower index glass tip.

FIG. 16 is a method of forming the optic fiber tip of FIG. 15.

FIG. 17 is a cross-sectional side view of a side-firing optic fiber tip with a coreless rod, a sapphire tube attached with an interference fit, and a lower index glass tip.

FIG. 18 is a method of forming the optic fiber tip of FIG. 17.

FIG. 19 is a cross-sectional side view of a side-firing optic fiber tip with a coreless rod, a sapphire tube attached with solder, and a lower index glass tip.

FIG. 20 is a method of forming the optic fiber tip of FIG. 19.

FIG. 21 is a cross-sectional side view of a side-firing optic fiber tip formed of a glass-filled sapphire tube with a lower index glass tip.

FIG. 22 is a method of forming the optic fiber tip of FIG. 21.

### DETAILED DESCRIPTION

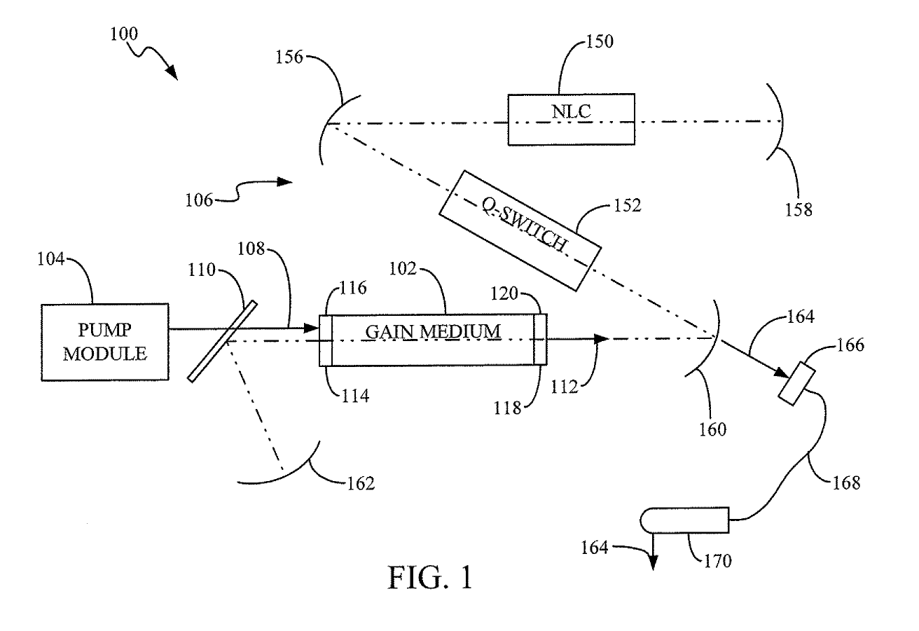

FIG. 1 is a schematic illustration of a laser system 100 in accordance with some embodiments. The laser system 100 includes a laser production systems 101, an optic fiber 168, and a side-firing delivery tip 170. Laser production system 101 includes a gain medium 102, a pump module 104 and a laser resonator 106. In one embodiment, the gain medium 102 is a doped crystalline host that is configured to absorb pump energy 108 generated by the pump module 104 having a wavelength that is within an operating wavelength (i.e., absorption spectra) range of the gain medium 102. In one embodiment, the gain medium 102 is end-pumped by the pump energy 108, which is transmitted through a folding mirror 110 that is transmissive at the wavelength of the pump energy 108. The gain medium 102 absorbs the pump energy 108 and responsively outputs laser light 112.

In some embodiments, the gain medium 102 is water cooled (not shown) along the sides of the host (not shown). In one embodiment, the gain medium 102 includes an undoped end cap 114 bonded on a first end 116 of the gain medium 102, and an undoped end cap 118 bonded on a second end 120 of the gain medium 102. In one embodiment, the end 120 is coated so that it is reflective at the pump energy wavelength, while transmissive at a resonant mode of the system 100. In this manner, the pump energy that is unabsorbed at the second end 120 is redirected back through the gain medium 102 to be absorbed.

The laser resonator 106 is configured to generate a harmonic of the laser light 112 output from the gain medium 102. In one embodiment, the laser resonator 106 includes a non-linear crystal (NLC) 150, such as a lithium borate (LBO) crystal or a potassium titanyl phosphate crystal (KTP), for generating a second harmonic of the laser beam 112 emitted by the gain medium 102.

In one embodiment, the gain medium 102 comprises a yttrium-aluminum-garnet crystal (YAG) rod with neodymium atoms dispersed in the YAG rod to form a Nd:YAG gain medium 102. The Nd:YAG gain medium 102 converts the pump light into the laser light 112 having a primary wavelength of 1064 nm. The laser resonator 106 generates the second harmonic of the 1064 nm laser light 164 having a wavelength of 532 nm. One advantage of the 532 nm wavelength is that it is strongly absorbed by hemoglobin in blood and, therefore, is useful in medical procedures to cut, vaporize and coagulate vascular tissue.

In one embodiment, the laser resonator 106 includes a Q-switch 152 that operates to change the laser beam 112 into a train of short pulses with high peak power to increase the conversion efficiency of the second harmonic laser beam.

The laser resonator 106 also includes reflecting mirrors 156, 158 and 162, folding mirror 110, and output coupler 160. The mirrors 110, 156, 158 and 162, and output coupler 160 are highly reflective at the primary wavelength (e.g., 1064 nm). The output coupler 160 is highly transmissive at the second harmonic output wavelength (e.g., 532 nm). The primary wavelength laser beam (e.g., 1064 nm) inside the resonator 106 bounces back and forth along the path between the minors 158 and 162, passing through the gain medium 102 and the non-linear crystal 150 to be frequency doubled to the second harmonic output wavelength (e.g., 532 nm) beam, which is discharged through output coupler 160 as the output laser 164. The Z-shaped resonant cavity can be configured as discussed in U.S. Pat. No. 5,025,446 by Kuizenga.

An optical coupler 166 receives output laser 164 and introduces laser 164 into optical fiber 168. The optic fiber generally comprises multiple concentric layers that include an outer nylon jacket, a buffer or hard cladding, a cladding and a core. The cladding is bonded to the core and the cladding and core operate as a waveguide that allows electromagnetic energy, such as laser beam 164, to travel through the core.

Laser beam 164 is guided along optic fiber 168 to side-firing delivery tip 170, which emits the laser beam at an angle to the axis of optic fiber 168.

Many of the embodiments described herein provide a side-firing optic fiber tip that emits light through a surface made of sapphire. Such surfaces are not prone to divitrification and as such should last longer than emitting surfaces made of glass.

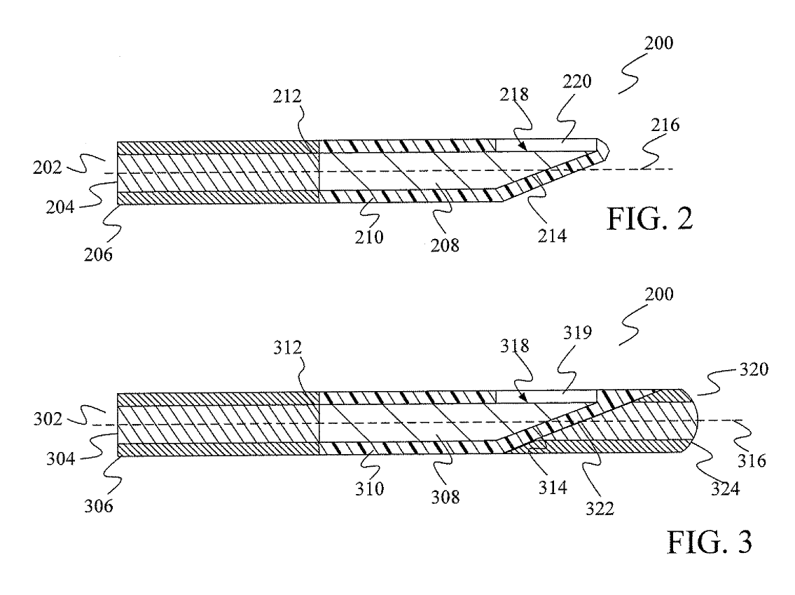

FIG. 2 provides a cross-sectional side view of a side-firing optic fiber tip 200 having a sapphire rod 208. Optic fiber tip 200 includes an optic fiber 202 that is constructed of a cylindrical core 204 that is concentrically surrounded by a cladding 206. Core 204 and cladding 206 can be constructed of fused-silica glass doped with various materials. Sapphire rod 208 has a glass coating 210 and is fused to optic fiber 202 at an interface 212. Under one embodiment, sapphire rod 208 is a cylindrical rod with a diameter that matches the diameter of core 204 and glass coating 210 has a thickness that exceeds the extinction depth of evanescent light at the total internal reflection surface by some multiple of the extinction depth such as ten. Sapphire rod 208 is shaped to include a total internal reflection surface 214 that is at an angle to an axis 216 of optic fiber 202 such that light guided by optic fiber 202 and transmitted through sapphire rod 208 reflects off total internal reflection surface 214 and is emitted through side surface 218 of sapphire rod 208. In the embodiment of FIG. 2, there is an opening 220 in glass coating 210 at emitting side surface 218 of sapphire rod 208. As such, the light emitted by sapphire rod 208 does not pass through glass coating 210 and therefore is not affected by the divitrification of glass coating 210.

FIG. 3 provides a cross-sectional side view of a side-firing optic fiber tip 300 with a sapphire rod. Side-firing optic fiber tip 300 in FIG. 3 is similar to side-firing optic fiber tip 200 of FIG. 2. In particular, side-firing optic fiber tip 300 includes an optic fiber 302 having a cylindrical core 304 that is concentrically surrounded by cladding 306. Core 304 and cladding 306 can be constructed of fused-silica glass doped with various materials. A shaped sapphire rod 308 is coated with glass 310 and is fused to optic fiber 302 at an interface 312. Under one embodiment, sapphire rod 308 is a cylindrical rod with a diameter that matches the diameter of core 304. Shaped sapphire rod 308 has been shaped to provide a total internal reflection surface 314 that is at an angle to an axis 316 of optic fiber 302 such that light guided by optic fiber 302 that is transmitted through sapphire rod 308 reflects off total internal reflection surface 314 and is emitted through emitting side surface area 318 of sapphire rod 308. In the embodiment of FIG. 3, glass coating 310 defines an opening 319 where glass coating 310 is not present over emitting side surface area 318 and as such, the light emitted by sapphire rod 308 does not pass through glass coating 310.

In side-firing optic fiber tip 300 of FIG. 3, a rounded optic fiber piece 320 has been shaped to provide a matching surface 322 that matches the exterior surface of glass coating 310 along internal reflection surface 314. This may be achieved by cleaving the optic fiber piece 320 or cutting and polishing the optic fiber piece 320. Surface 322 is bonded to glass coating 310, preferably by fusing surface 322 to glass coating 310. The free end of optic fiber piece 320 is rounded under one embodiment.

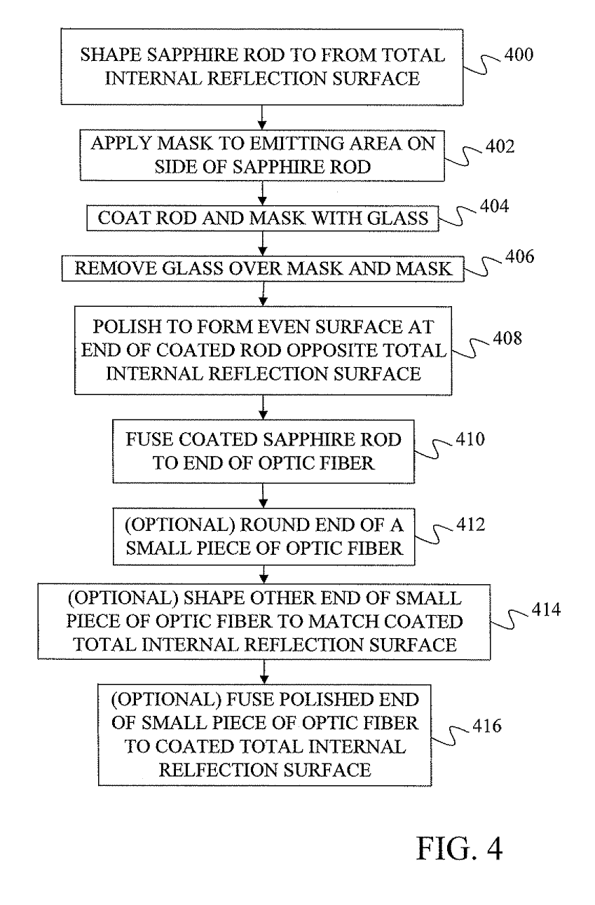

FIG. 4 provides a flow diagram for forming the side-firing optic fiber tips of FIGS. 2 and 3. The method of FIG. 4 begins at step 400, where a sapphire rod is polished to form a total internal reflection surface. At step 402, a mask is applied to the area on the side of the sapphire rod where light will be emitted from the sapphire rod after reflecting off the total internal reflection surface. In step 404, the rod and mask are coated with glass. After the glass coating is set, the glass over the mask and the mask are removed at step 406. The coated sapphire rod is then polished in step 408 to form an even surface at the end of the coated rod opposite the total internal reflection surface. At step 410, the coated sapphire rod is fused to the end of the optic fiber. Under one embodiment, the sapphire rod is fused to the optic fiber using CO₂ laser fusion. With the performance of step 410, side-firing optic fiber tip 200 of FIG. 2 has been produced.

To produce side-firing optic fiber tip 300 of FIG. 3, optional step 412 of FIG. 4 is performed which involves rounding the end of a small piece of optic fiber. At step 414, the other end of the small piece of optic fiber is cleaved or cut and polished to match the coated total internal reflection surface. The matching end of the small piece of optic fiber is then fused to the coated total internal reflection surface at step 416 to form side-firing optic fiber tip 300.

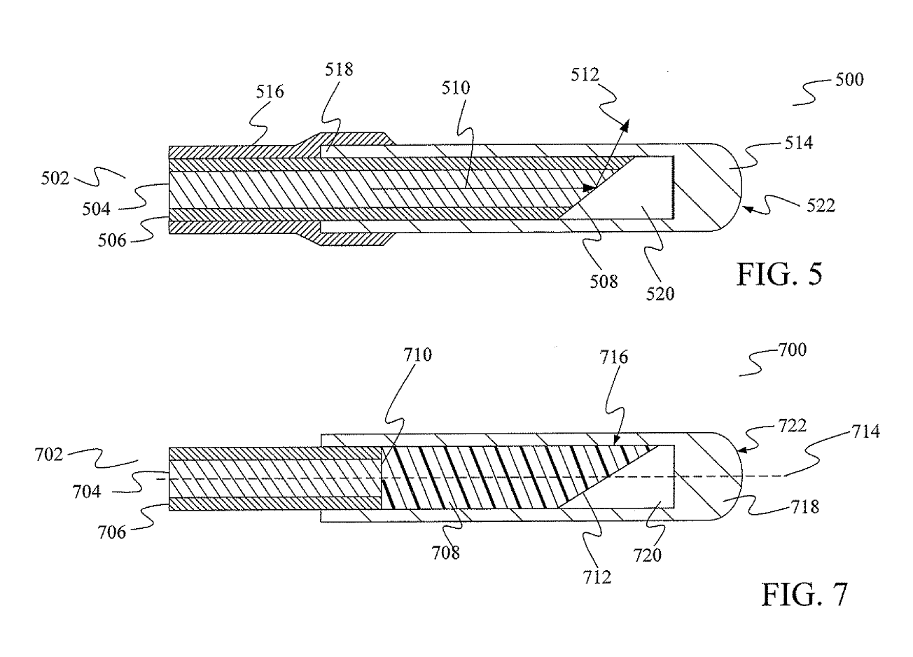

FIG. 5 provides a cross-sectional side view of a side-firing optic fiber tip 500 with a sapphire casing attached with an interference fit. In FIG. 5, side-firing optic tip 500 includes an optic fiber 502 formed of a cylindrical core 504 that is concentrically surrounded by a cladding 506. The end of optic fiber 502 has been shaped to form a total internal reflection surface 508, such that light 510 guided by optic fiber 502 reflects off of total internal reflection surface 508 to produce emitted light 512.

A closed sapphire tube 514 surrounds the end of optic fiber 502 and is bonded to optic fiber 502 using an interference fit. An optional polymer coating 516 covers optic fiber 502 and an open end 518 of sapphire tube 514. Sapphire tube 514 and total internal reflection surface 508 define a cavity 520, which under one embodiment contains air. Under some embodiments, sapphire tube 514 has a closed rounded end 522

Light that is reflected off total internal reflection surface 508 and that exits the side of optic fiber 502 passes through sapphire tube 514. As a result, the portion of the optic fiber tip 500 that is closest to the target and that emits light 512, is made of sapphire, which is not prone to divitrification.

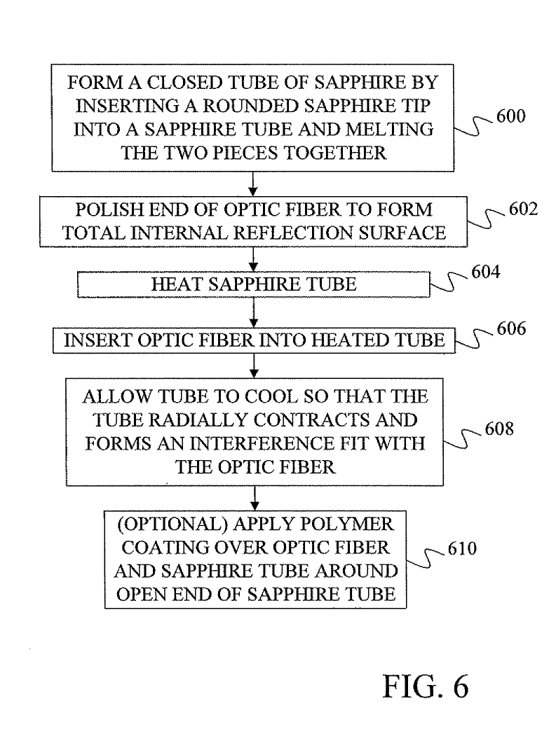

FIG. 6 provides a flow diagram for forming side-firing optic fiber tip 500. In step 600, a closed tube of sapphire is formed by inserting a rounded sapphire tip into a sapphire tube and melting the two pieces together. At step 602, the end of an optic fiber is cleaved or cut and polished to form a total internal reflection surface. The closed sapphire tube is then heated at step 604 and the optic fiber is inserted into the closed heated tube and step 606. The sapphire tube is then allowed to cool so that the sapphire tube radially contracts and forms an interference fit with the optic fiber at step 608. The optional polymer coating may then be applied over the optic fiber and the open end of the sapphire tube at step 610.

FIG. 7 provides a cross-sectional side view of a side-firing optic fiber tip 700 with a careless rod and a sapphire casing attached with an interference fit. In FIG. 7, side-firing optic fiber tip 700 is formed of an optic fiber 702 having a cylindrical core 704 that is concentrically surrounded by a cladding 706. A careless rod 708 is fused to optic fiber 702 at an interface 710. Under one embodiment, coreless rod 708 is a cylindrical rod with a diameter that matches the outer diameter of cladding 706. The end of coreless rod 708 opposite interface 710 is shaped to form a total internal reflection surface 712 that is at an angle to an axis 714 of side-firing optic fiber tip 700. Total internal reflection surface 712 causes light guided by optic fiber 702 that is transmitted through careless rod 708 to be reflected out a side surface 716 of coreless rod 708.

Careless rod 708 and an end of optic fiber 702 are encased in a closed sapphire tube 718 such that light emitted through side surface 716 of careless rod 708 passes through sapphire tube 718. Sapphire tube 718 is bonded to coreless rod 708 and optic fiber 702 with an interference fit. Under the embodiment of FIG. 7, sapphire tube 718 and total internal reflection surface 712 define a cavity 720 that contains air. Under some embodiments, sapphire tube 718 has a closed rounded end 722.

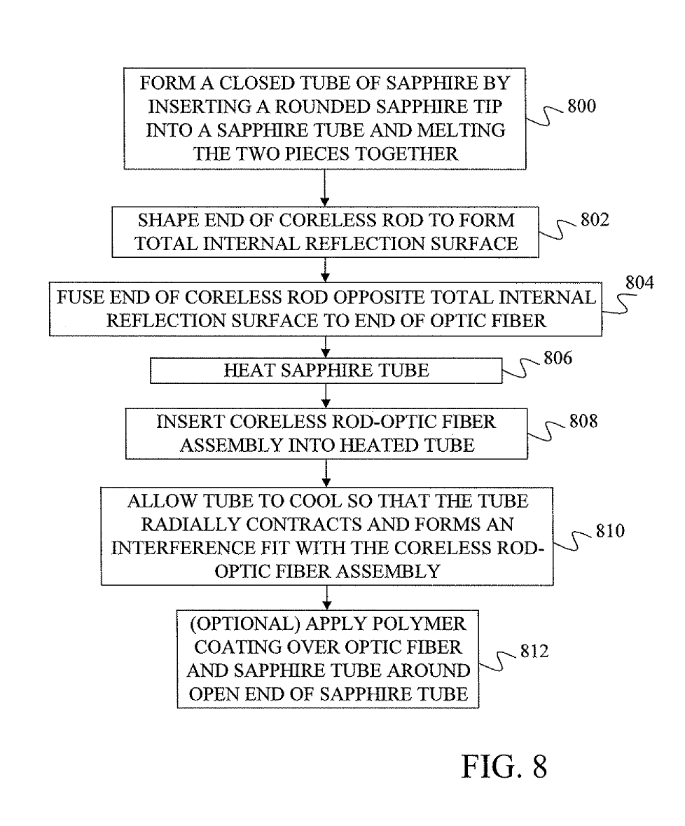

FIG. 8 provides a flow diagram for forming the side-firing fiber optic tip 700 of FIG. 7. In step 800, a closed tube of sapphire is formed by inserting a rounded sapphire tip into a sapphire tube and melting the two pieces together. In step 802, the end of a careless rod is shaped by cleaving or cutting and polishing to form a total internal reflection surface. The end of the coreless rod opposite the total internal reflection surface is then fused to the end of the optic fiber in step 804. At step 806, the sapphire tube is heated and the careless rod-optic fiber assembly is inserted in to the heated tube at step 808. The sapphire tube is allowed to cool at step 810 so that the tube radially contracts and forms an interference fit with the careless rod-optic fiber assembly. At step 812, an optional polymer coating is placed over the optic fiber and the sapphire tube around the open end of the sapphire tube.

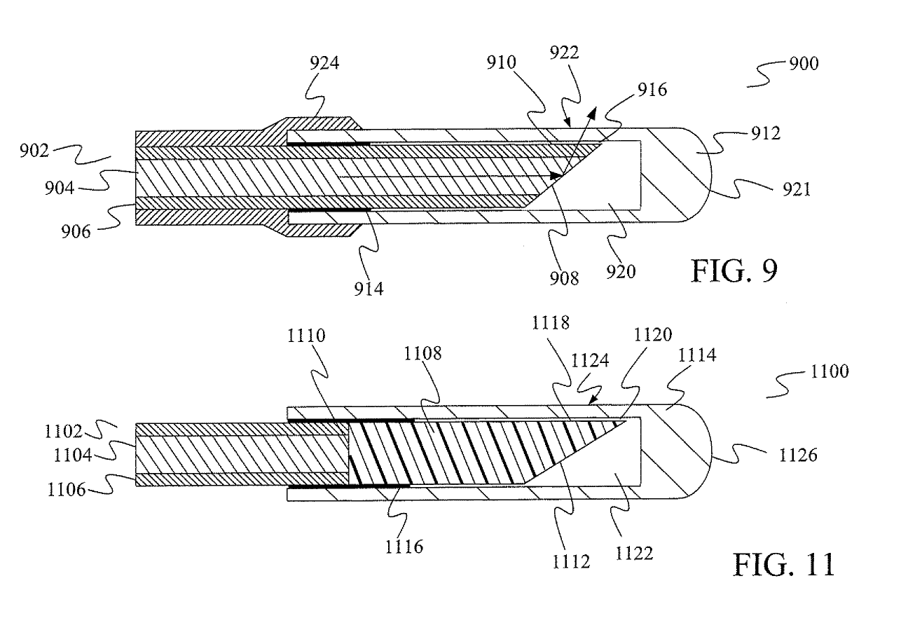

FIG. 9 provides a cross-sectional side view of a side-firing optic fiber tip 900 with a sapphire casing attached with solder. Side-firing optic fiber tip 900 of FIG. 9 includes an optic fiber 902 formed of a cylindrical core 904 that is concentrically surrounded by a cladding 906. Optic fiber 902 has a free end that is shaped to faun a total internal reflection surface 908 such that light guided through optic fiber 902 reflects off total internal reflection surface 908 and is emitted through side surface 910 of optic fiber 902.

The end of optic fiber 902 is surrounded by a closed sapphire tube 912 that is bonded to optic fiber 902 by a solder layer 914 that extends concentrically about the exterior of cladding 906 and about the cylindrical interior of the end of sapphire tube 912. An air space 916 exists between side 910 of optic fiber 902 and sapphire tube 912. Light emitted by side surface 910 of optic fiber 902 passes through sapphire tube 912 and is emitted toward a target at an exterior side surface 922 of sapphire tube 912. A cavity 920 extends between total internal reflection surface 908 and sapphire tube 912. An optional polymer coating 924 is placed over optic fiber 902 and the open end of sapphire tube 912. Closed sapphire tube 912 has a closed rounded end 921.

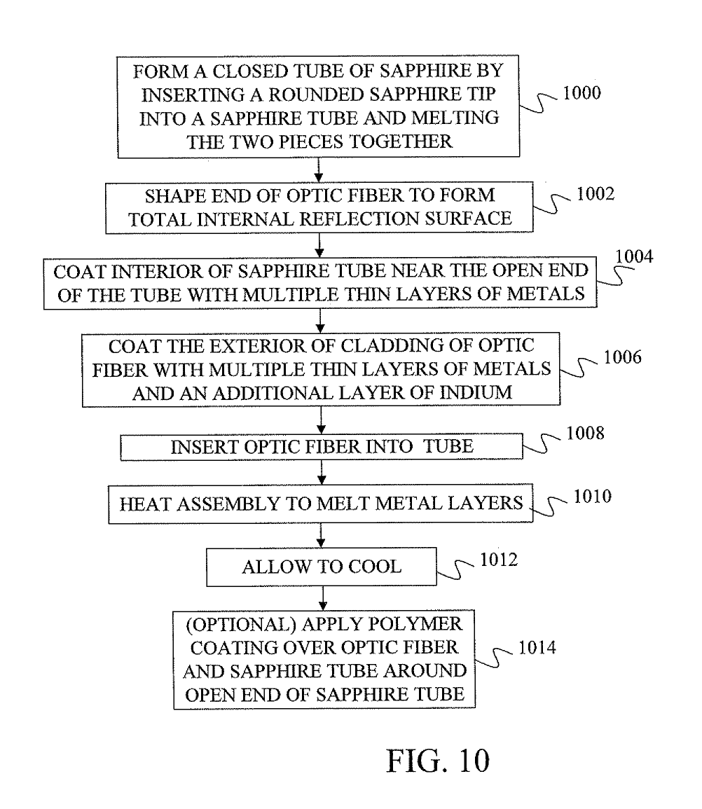

FIG. 10 provides a flow diagram of a method of forming the side-firing optic fiber tip 900 of FIG. 9. In step 1000, a closed tube of sapphire is formed by inserting a rounded sapphire tip into a sapphire tube and melting the two pieces together. At step 1002, the end of the optic fiber is shaped by cleaving or cutting and polishing to form the total internal reflection surface. At step 1004, the interior of the sapphire tube near the open end of the tube is coated with multiple thin layers of metal. For example, the interior of the tube may be coated with a layer of chromium, an optional layer of copper, a layer of nickel, and a layer of gold, with the total thickness of all the layers being 35,000 angstroms. An aluminum layer can replace the nickel layer under some embodiments. In addition, an outer layer of indium can be added. Care is taken to keep the metal layers far away from the regions where the high power laser beam will cross the interfaces.

At step 1006, the exterior of the cladding of the optic fiber is coated with multiple thin layers of metals and an additional layer of indium. Under one embodiment, the multiple layers of metals include a layer of chromium, an optional layer of copper, a layer of nickel, and a layer of gold, were there layer of nickel maybe be replaced with an aluminum layer under some embodiments. An outer layer of indium is then applied. The total thickness of the metal layers applied to the cladding is 35,000 angstroms. Care is taken to keep the metal layers far away from the regions where the high power laser beam will cross the interfaces.

At step 1008, the coated optic fiber is inserted into the sapphire tube and the assembly is heated at step 1010 to melt the metal layers. The melted metal layers are allowed to cool at step 1012 thereby forming a soldered connection between sapphire tube 912 and cladding 906. At step 1014, an optional polymer coating layer may be applied over the optic fiber and sapphire tube around the open end of the sapphire tube. It is also possible that the gold layers on the sapphire tube and the optic fiber can be melted and joined without the use of the indium layer. In such embodiments, the pressure required to bring the gold layers together can be derived from pre-heating the sapphire tube and inserting the coated fiber into the sapphire tube. Cooling and collapsing of the sapphire tube will exert the required pressure on the gold interfacial layers.

FIG. 11 provides a cross-sectional side view of a side-firing optic tip 1100 having a coreless rod and a sapphire casing attached with solder. In FIG. 11, an optic fiber 1102 consisting of a cylindrical core 1104 that is concentrically surrounded by cladding 1106 is fused to a cylindrical coreless rod 1108 at an interface 1110. Coreless rod 1108 is shaped so that is has a total internal reflection surface 1112. A sapphire tube 1114 encases coreless rod 1108 and is bonded to coreless rod 1108 and optic fiber 1102 through a cylindrical solder connection 1116. Light guided by optic fiber 1102 that passes into coreless rod 1108 is reflected off total internal reflection surface 1112 and is emitted through a side surface 1118 of coreless rod 1112 and out through a side surface 1124 of sapphire tube 1114. An air gap 1120 exists between side surface 1118 of coreless rod 1108 and sapphire tube 1114. In addition, a cavity 1122 is defined between total internal reflection surface 1112 and sapphire tube 1114. Under one embodiment, sapphire tube 1114 has a closed rounded end 1126.

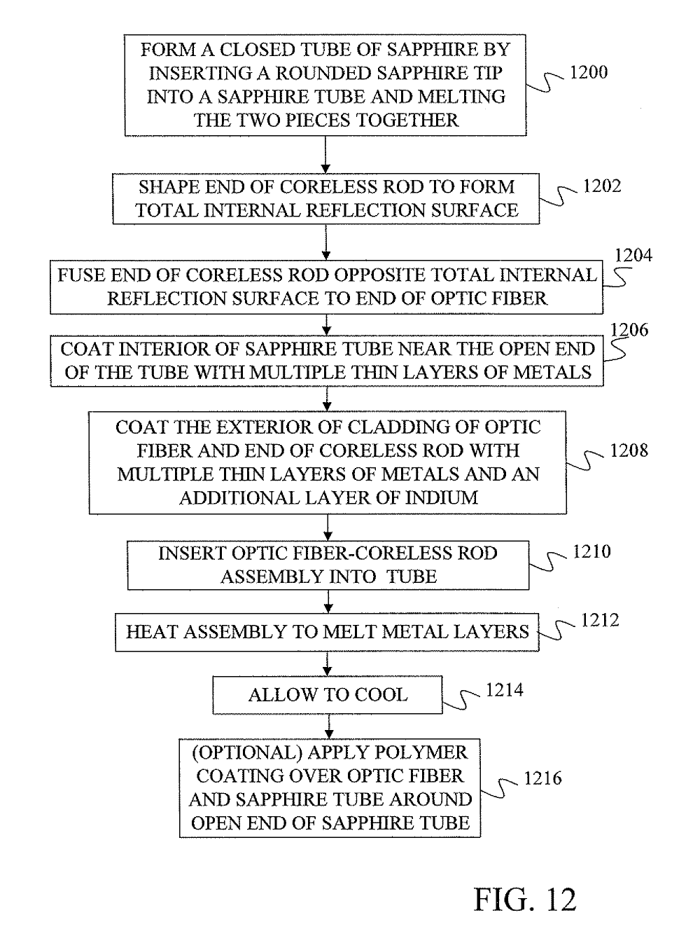

FIG. 12 provides a flow diagram of a method of forming the side-firing optic fiber tip 1100 of FIG. 11. In step 1200 of FIG. 12, a closed tube of sapphire is formed by inserting a rounded sapphire tip into a sapphire tube and melting the two pieces together. An end of the coreless rod is then shaped by cleaving or cutting and polishing in step 1202 to form the total internal reflection surface. An end of the coreless rod opposite the total internal reflection surface is then fused to the end of the optic fiber at step 1204.

The interior of the sapphire tube near the open end of the tube is coated with multiple thin layers of metals at step 1206. Under one embodiment, the thin layers of metal include a chromium layer, an optional copper layer, a nickel layer, and a gold layer such that the total thickness of the layers is 35,000 angstroms. An aluminum layer in some embodiments replaces the nickel layer. An outer layer of indium is also added under some embodiments. Care is taken to keep the metal layers far away from the regions where the high power laser beam will cross the interfaces.

At step 1208, the exterior of the cladding of the optic fiber and the end of the coreless rod are coated with multiple thin layers of metals and an additional layer of indium. In one particular embodiment, a layer of chromium, an optional layer of copper, a layer of nickel, and a layer of gold are applied to the optic fiber and the end of the coreless rod. An aluminum layer under some embodiments replaces the nickel layer. An indium layer is added to the exterior of the multiple thin layers of metals. Care is taken to keep the metal layers far away from the regions where the high power laser beam will cross the interfaces.

At step 1210, the optic fiber-coreless rod assembly is inserted into the tube and the assembly is heated to melt the metal layers at step 1212. At step 1214, the assembly is allowed to cool thereby forming a soldered connection between the sapphire tube and the optic fiber-coreless rod assembly. At step 1216, an optional polymer coating may be applied over the optic fiber and the sapphire tube around the open end of the sapphire tube.

It is also possible that the gold layers on the sapphire tube and the optic fiber can be melted and joined without the use of the indium layer. In such embodiments, the pressure required to bring the gold layers together can be derived from pre-heating the sapphire tube and inserting the coated fiber into the sapphire tube. Cooling and collapsing of the sapphire tube will exert the required pressure on the gold interfacial layers.

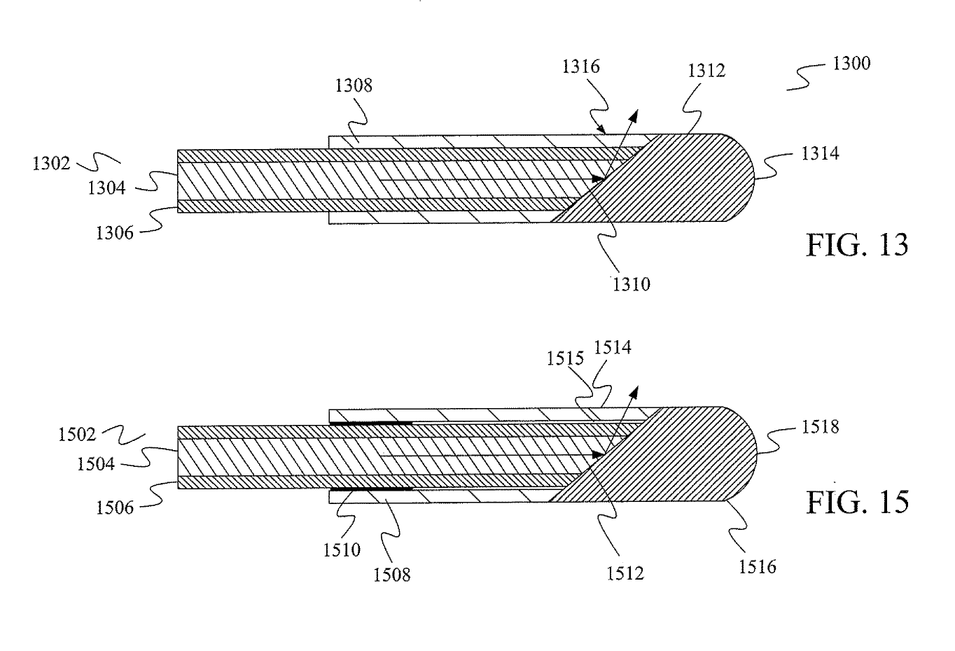

FIG. 13 provides a cross-sectional side view of a side-firing optic fiber tip 1300 with a sapphire tube attached with an interference fit and a lower index glass tip. Side-firing optic fiber tip 1300 includes an optic fiber 1302 formed of a cylindrical core 1304 that is concentrically surrounded by a cladding 1306. Optic fiber 1302 is inserted within a cylindrical sapphire tube 1308 and is bonded to sapphire tube 1308 using an interference fit. Sapphire tube 1308 and the end of optic fiber 1302 are shaped to form a total internal reflection surface 1310 in optic fiber 1302.

A glass tip 1312 having an end that matches total internal reflection surface 1310 is fused to total internal reflection surface 1310 and is wet sealed to sapphire tube 1308 to keep out air or other contaminants. The glass of glass tip 1312 is chosen such that it wets the sapphire well enough to form a good seal. Glass tip 1312 has a rounded end 1314 and is made of a glass with a lower index of refraction than core 1304 of fiber optic 1302. Since glass tip 1312 has a lower index of refraction than optic fiber core 1304, light guided by optic fiber 1302 is reflected off total internal reflection surface 1310 and is emitted from side surface 1316 of sapphire tube 1308 after passing through cladding 1306 of optic fiber 1302. Under some embodiments, glass tip 1312 is cylindrical and has an outer diameter that matches the outer diameter of sapphire tube 1308.

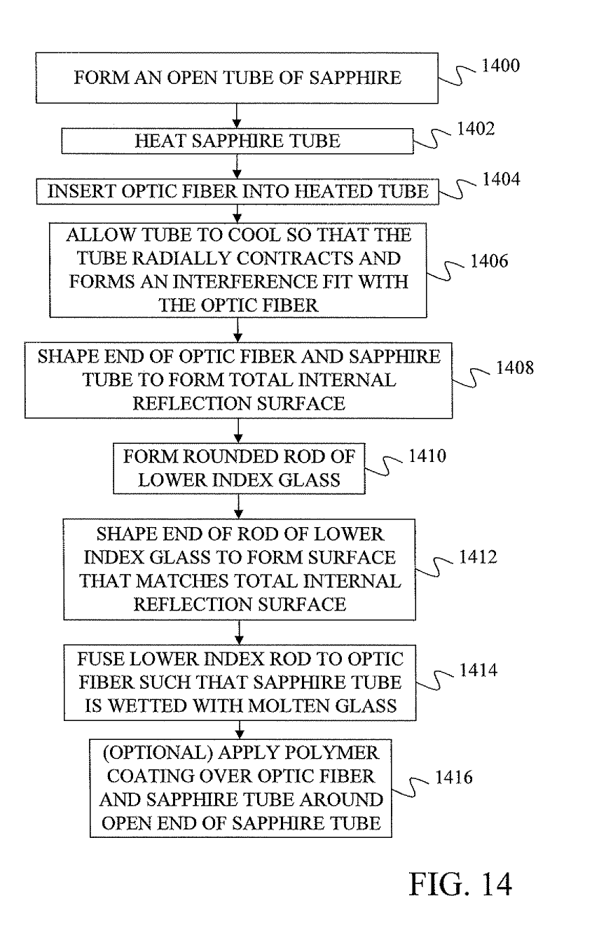

FIG. 14 provides a flow diagram of a method of forming side-firing optic fiber tip 1300 of FIG. 13. At step 1400, an open tube of sapphire is formed. In step 1402, the sapphire tube is heated and the optic fiber is inserted into the heated tube at step 1404. The tube is allowed to cool at step 1406 so that the tube radially contracts and forms an interference fit with the optic fiber.

At step 1408, the free end of the optic fiber-sapphire tube assembly is shaped by cleaving or by cutting and polishing to form a total internal reflection surface. At step 1410, a rounded rod of lower index glass is formed. An end of the rod of glass is then shaped to form a surface that matches the total internal reflection surface at step 1412. At step 1414, the lower index rod is fused to the optic fiber such that the sapphire tube is wetted with molten glass. At step 1416, an optional polymer coating may be applied over the optic fiber and the sapphire tube around the open end of the sapphire tube.

FIG. 15 provides a cross-sectional side view of a side-firing optic fiber tip 1500 with a sapphire tube attached with solder and a lower-index glass tip. Side-firing optic fiber tip 1500 includes an optic fiber 1502 having a cylindrical core 1504 that is concentrically surrounded by a cladding 1506. Optic fiber 1502 is located within a cylindrical sapphire tube 1508 and is bonded to sapphire tube 1508 by a cylindrical solder connection 1510.

Sapphire tube 1508 and optic fiber 1502 have a shaped end that forms a total internal reflection surface 1512 such that light guided along optic fiber 1502 reflects off total internal reflection surface 1512 and is emitted through a side surface 1514 of sapphire tube 1508. A cylindrical space 1515 extends between cladding 1506 and sapphire tube 1508. A glass tip 1516 is fused to optic fiber 1502 at total internal reflection surface 1512 and is wet sealed to sapphire tube 1508 to keep out air or other contaminants. The glass of glass tip 1516 is chosen so that it wets the sapphire well enough to form a good seal. Glass tip 1516 has a rounded end 1518 opposite total internal reflection surface 1512 and has a lower index of refraction than core 1504 allowing for total internal reflection at total internal reflection surface 1512.

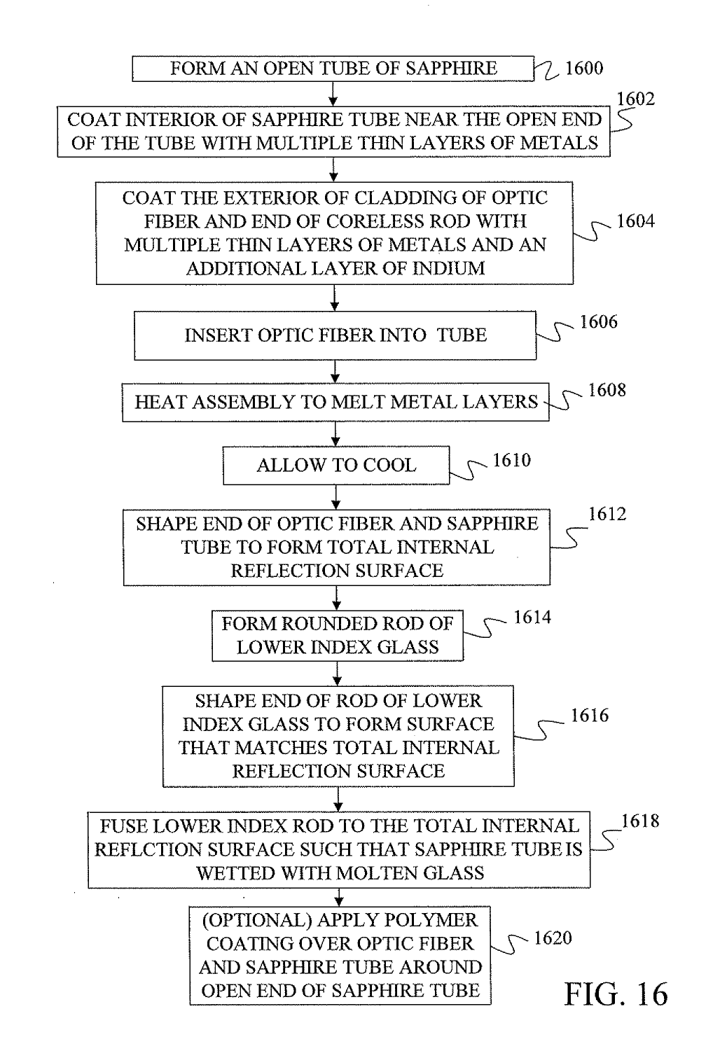

FIG. 16 provides a method of forming side-firing optic fiber tip 1500 of FIG. 15. In step 1600, an open tube of sapphire is formed. In step 1602, the interior of the sapphire tube at one end is coated with multiple thin layers of metals. Under one embodiment, these thin layers of metals include a chromium layer, an optional layer of copper, a nickel layer, and a gold layer. The total thickness of the layers is 35,000 angstroms under this embodiment. An aluminum layer can replace the nickel layer in some embodiments. An outer layer of indium is added in some embodiments. Care is taken to keep the metal layers far away from the regions where the high power laser beam will cross the interfaces.

At step 1604, the exterior of the cladding of the optic fiber is coated with multiple thin layers of metal and an additional layer of indium. The thin layers of metal under one embodiment include a chromium layer, an optional copper layer, a nickel layer, and a gold layer, wherein an aluminum layer can replace the nickel layer under some embodiments. Care is taken to keep the metal layers far away from the regions where the high power laser beam will cross the interfaces.

At step 1606, the optic fiber is inserted into the tube and the assembly is heated to melt the metal layers at step 1608. The assembly is allowed to cool at step 1610 thereby forming a soldered connection between the sapphire tube and the optic fiber.

It is also possible that the gold layers on the sapphire tube and the optic fiber can be melted and joined without the use of the indium layer. In such embodiments, the pressure required to bring the gold layers together can be derived from pre-heating the sapphire tube and inserting the coated fiber into the sapphire tube. Cooling and collapsing of the sapphire tube will exert the required pressure on the gold interfacial layers.

At step 1612, the end of the optic fiber and the sapphire tube is shaped by cleaving or by cutting and polishing to form the total internal reflection surface. A rounded rod of lower index of refraction glass is then formed at step 1614. The rod of glass has a lower index of refraction than the core of the optic fiber. The end of the lower index of refraction glass rod that is opposite the rounded end is shaped in step 1616 so that it forms a surface that matches the total internal reflection surface of the optic fiber and sapphire tube. At step 1618, the lower index of refraction rod is fused to the optic fiber such that the sapphire tube is wetted with molten glass. At step 1620, an optional polymer coating may be applied over the optic fiber and the open end of the sapphire tube.

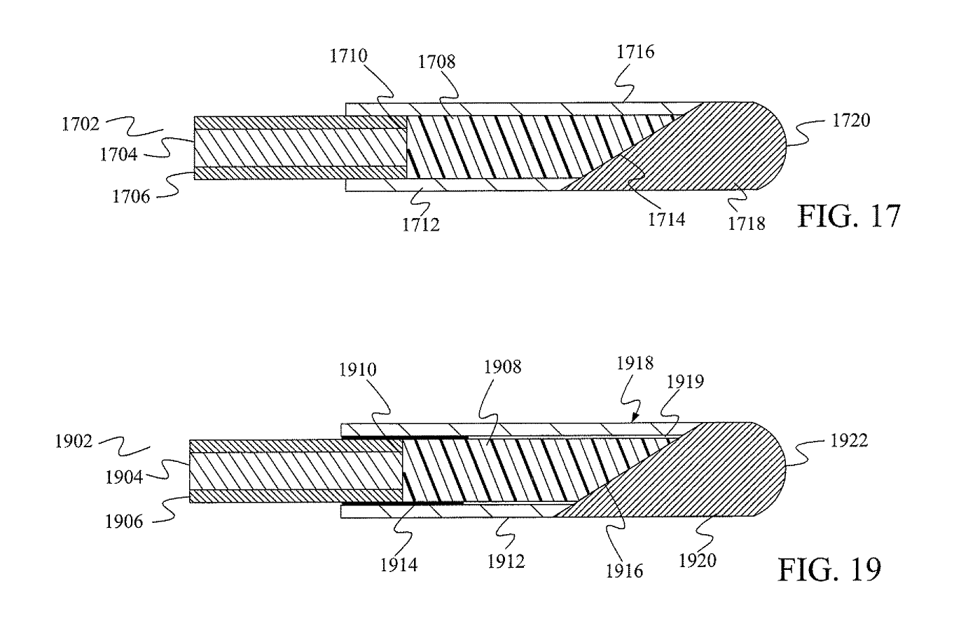

FIG. 17 provides a cross-sectional side view of a side-firing optic fiber tip 1700 with a careless rod, a sapphire tube attached with an interference fit and a lower-index glass tip. Side-firing optic fiber tip 1700 includes an optic fiber 1702 having a cylindrical core 1704 and a cladding 1706 that concentrically surrounds the core 1704. A careless rod 1708 is fused to optic fiber 1702 at an interface 1710. Under one embodiment, careless rod 1708 is a cylindrical rod with a diameter that matches the outer diameter of cladding 1706. A cylindrical sapphire tube 1712 surrounds an end of optic fiber 1702 and careless rod 1708 and is bonded to optic fiber 1702 and careless rod 1708 using an interference fit. An end of careless rod 1708 and sapphire tube 1712 is polished to define a total internal reflection surface 1714 in careless rod 1708. Total internal reflection surface 1714 causes light guided by optic fiber 1702 and transmitted to careless rod 1708 to be reflected out a side surface 1716 of sapphire tube 1712.

A glass rod 1718 having a lower index of refraction than coreless rod 1708 is fused to careless rod 1708 at total internal reflection surface 1714 and is wet sealed to sapphire tube 1712 to keep out air or other contaminants. The glass of glass rod 1718 is chosen so that it wets the sapphire well enough to form a good seal. Under one embodiment, glass rod 1718 is cylindrical with a diameter that matches the outer diameter of sapphire tube 1712 and has a rounded end 1720.

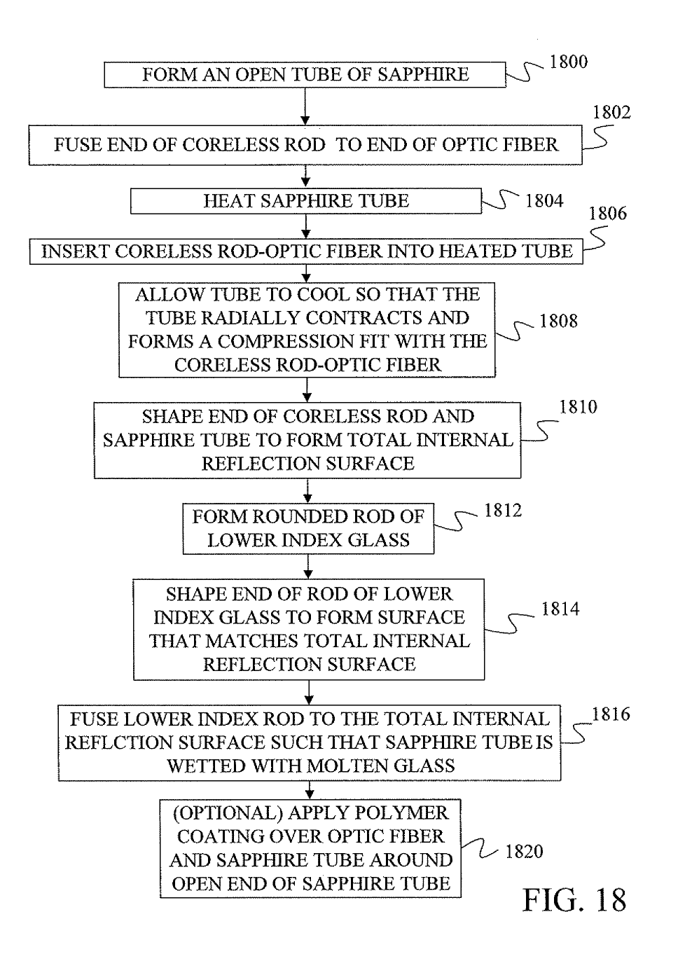

FIG. 18 provides a flow diagram of a method of forming side-firing optic fiber tip 1700 of FIG. 17. In step 1800, an open tube of sapphire is formed and at step 1802 the end of a careless rod is fused to an end of an optic fiber. The sapphire tube is heated at step 1804 and the careless rod-optic fiber assembly is inserted into the heated tube at step 1806. At step 1808, the sapphire tube is allowed to cool so that the sapphire tube radially contracts and forms a compression fit with the careless rod-optic fiber assembly.

At step 1810, the end of the optic fiber and sapphire tube are shaped by cleaving or by cutting and polishing to form the total internal reflection surface. At step 1812, a rod of glass having a lower index of refraction than the coreless rod is formed with a rounded end. At step 1814, an end of the rod of glass with the lower index of refraction is shaped to form a surface that matches the total internal reflection surface of the coreless rod. The glass rod with lower index of refraction is then fused to the total internal reflection surface at step 1816 such that the sapphire tube is wetted with molten glass. At step 1818, an optional polymer coating is applied over the optic fiber and the open end of the sapphire tube.

FIG. 19 provides a cross-sectional side view of a side-firing optic fiber tip 1900 with a coreless rod, a sapphire tube attached with solder, and a lower-index glass tip. In FIG. 19, side-firing optic fiber tip 1900 includes optic fiber 1902 having a cylindrical core 1904 concentrically surrounded by a cladding 1906. Optic fiber 1902 is fused with a coreless rod 1908 at an interface 1910. Optic fiber 1902 and coreless rod 1908 are within a cylindrical sapphire tube 1912 and are bonded to cylindrical sapphire tube 1912 by a cylindrical solder connection 1914. A cylindrical space 1919 extends between coreless rod 1908 and sapphire tube 1912.

The end of coreless rod 1908 and sapphire tube 1912 are shaped to form a total internal reflection surface 1916 on coreless rod 1908, which causes light guided by optic fiber 1902 and transmitted through coreless rod 1908 to reflect out of side surface 1918 of sapphire tube 1912. Total internal reflection surface 1916 is fused with glass rod 1920, which has a lower index of refraction than coreless rod 1908 thereby causing the total internal reflection within coreless rod 1908. Glass rod 1920 is a cylindrical rod having a diameter that matches the outer diameter of sapphire tube 1912 and includes a rounded end 1922 under one embodiment. Glass rod 1920 is wet sealed to sapphire tube 1912 to keep out air or other contaminants. The glass of glass rod 1920 is chosen so that it wets the sapphire well enough to form a good seal.

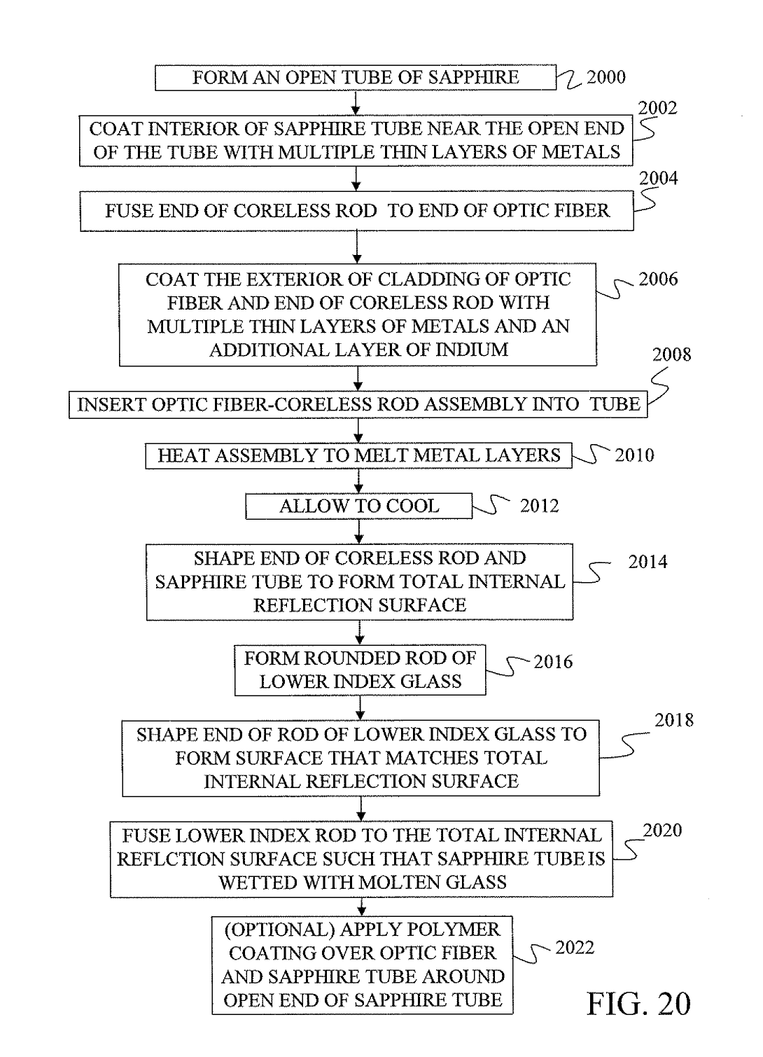

FIG. 20 provides a flow diagram of a method for forming the side-firing optic fiber tip 1900 of FIG. 19. In step 2000, an open tube of sapphire is formed. In step 2002, the interior of the sapphire tube is coated at an end with multiple thin layers of metals. Under one embodiment, the thin layers of metal include a chromium layer, an optional copper layer, a nickel layer, and a gold layer. The combined thickness of the metal layers, under one embodiment, is 35,000 angstroms. Under additional embodiments, the nickel layer is replaced with an aluminum layer. In further embodiments an outer layer of indium is also added. Care is taken to keep the metal layers far away from the regions where the high power laser beam will cross the interfaces.

At step 2004, an end of a coreless rod is fused to an end of an optic fiber. The exterior of the cladding of the optic fiber and the end of the coreless rod are then coated with multiple thin layers of metals and an additional layer of indium at step 2006. Under one embodiment, the thin layers of metal include a chromium layer, an optional copper layer, a nickel layer, and a gold layer. In further embodiments, an aluminum layer replaces the nickel layer. Care is taken to keep the metal layers far away from the regions where the high power laser beam will cross the interfaces.

In step 2008, the optic fiber-coreless rod assembly is inserted into the tube and at step 2010 the assembly is heated to melt the metal layers on the optic fiber-coreless rod assembly and the interior of the sapphire tube. After the assembly cools at step 2012, a solder connection has been made between the sapphire tube and the optic fiber-coreless rod assembly. The end of the coreless rod and sapphire tube are then shaped by cleaving or by cutting and polishing to form the total internal reflection surface at step 2014.

It is also possible that the gold layers on the sapphire tube and the optic fiber can be melted and joined without the use of the indium layer. In such embodiments, the pressure required to bring the gold layers together can be derived from pre-heating the sapphire tube and inserting the coated fiber into the sapphire tube. Cooling and collapsing of the sapphire tube will exert the required pressure on the gold interfacial layers.

At step 2016 a rounded rod of lower index of refraction glass is formed. This rod of glass has a lower index of refraction than the coreless rod. At step 2018, the lower index of refraction glass is then shaped on one end to form a surface that matches the total internal reflection surface. The lower index of refraction rod is then fused to the total internal reflection surface at step 2020 such that the sapphire tube is wetted with molten glass. At step 2022 an optional polymer coating is applied over the optic fiber and the open end of the sapphire tube.

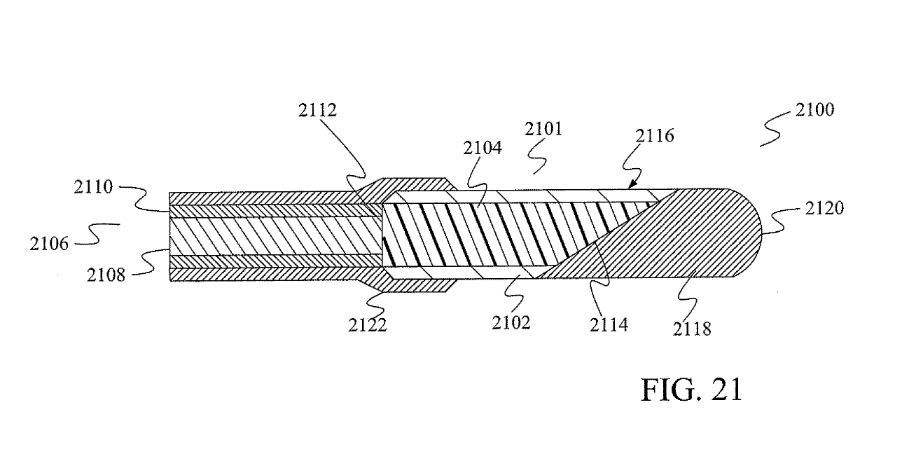

FIG. 21 provides a cross-sectional side view of a side-firing optic fiber tip 2100 formed of a glass-filled sapphire tube 2101 and a lower index of refraction glass tip 2118.

In FIG. 21 a cylindrical sapphire tube 2102 is filled with glass 2104 to form glass-filled sapphire tube 2101. At a junction 2112, glass 2104 is fused with an optic fiber 2106 consisting of a cylindrical core 2108 and a cladding 2110 that concentrically surrounds core 2108.

Glass-filled sapphire tube 2101 has a shaped end that form a total internal reflection surface 2114 such that light guided by optic fiber 2106 and transmitted into glass 2104 is reflected off total internal reflection surface 2114 so that it exits out of a side surface 2116 of sapphire tube 2102.

A glass rod 2118 having a lower index of refraction than glass 2104 is fused to total internal reflection surface 2114, is wet sealed to sapphire tube 2102, and has a rounded end 2120. The glass of glass rod 2118 is chosen so that it wets the sapphire well enough to form a good seal. The lower index of refraction of glass rod 2118 relative to glass 2104 allows for total internal reflection at total internal reflection surface 2114. A polymer coating 2122 is applied over optic fiber 2106 and one end of glass filled sapphire tube 2101.

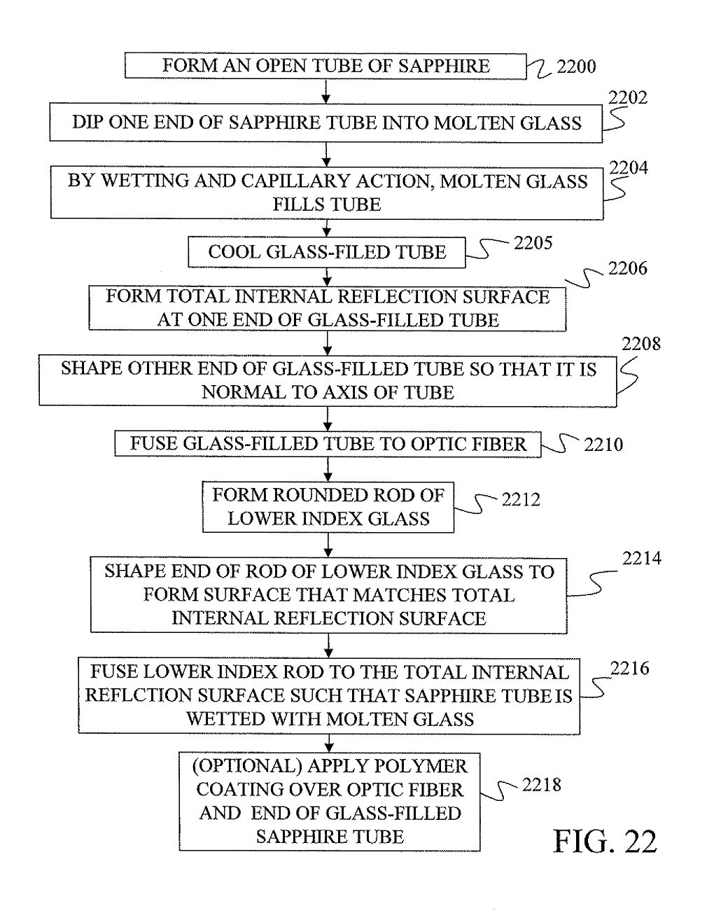

FIG. 22 provides a flow diagram of a method of forming side-firing optic fiber tip 2100 of FIG. 21.

In step 2200, an open tube of sapphire is formed and at step 2202 one end of the sapphire tube is dipped in to molten glass. Under some embodiments, a plurality of sapphire tubes are dipped at the same time in a pool of molten glass. At step 2204, by wetting and capillary action, molten glass fills the sapphire tube and then the tube is cooled at step 2005. Glass is known to be robust to residual compressive stresses generated by the higher coefficient of thermal expansion of the sapphire tubes.

At step 2206, a total internal reflection surface is formed at one end of the glass-filled sapphire tube. The other end of the glass-filled sapphire tube is polished so that it is normal to an axis of the tube at step 2208. At step 2210, the glass-filled sapphire tube is fused to the optic fiber.

At step 2212, a rounded cylindrical rod of glass is formed. This rod of glass has a lower index of refraction than the glass in the glass-filled sapphire tube. At step 2214 an end of the rod of lower index of refraction glass is shaped to form a surface that matches the total internal reflection surface. The lower index of refraction rod is then fused to the glass filled tube at step 2216 such that the sapphire tube is wetted with molten glass. At step 2218, an optional polymer coating is applied over the optic fiber and an end of the glass-filled sapphire tube.

In the discussion above, cylindrical sapphire tubes are used. In other embodiments, tubes with square or rectangular cross-section shapes are used instead. The fusion interface between different sections of silica glass is shown above as being perpendicular to the axis of the fiber in some embodiments. Perpendicularity is not crucial to the operation of the device, and other angles may be dictated by the desired exit angle of the laser beam from the device for given indices of refraction of the media traversed. An optional metal cap and/or polymer overcoat that do not interfere with the path of the high power laser beam are applicable to all embodiments discussed above. Note that fusion splices between glasses may be made by a number of commercially established methods. Of particular applicability to fusion restricted to selective regions is the use of lasers to melt the glass in the desire regions.

In the embodiments above, the optic fiber and coreless rod are constructed of fused-silica glass doped with various materials to provide desired indices of refraction.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An article of manufacture comprising:
an optic fiber comprising a core and a cladding surrounding the core;
a sapphire tube bonded to the optic fiber;
a coreless rod that is fused to at least the core of the optic fiber;
a total internal reflection surface positioned such that light guided within the core of the optic fiber reflects off the total internal reflection surface and through the sapphire tube, wherein the total internal reflection surface is formed on the coreless rod.

2. (canceled)

3. The article of manufacture of claim 1 wherein the sapphire tube comprises a closed end and the total internal reflection surface and the closed end of the sapphire tube together define a cavity.

4. (canceled)

5. (canceled)

6. (canceled)

7. (canceled)

8. (canceled)

9. (canceled)

10. The article of manufacture of claim 1 further comprising a rounded glass rod fused to the total internal reflection surface of the coreless rod.

11. The article of manufacture of claim 10 wherein the rounded glass rod is further sealed to the sapphire tube.

12. The article of manufacture of claim 1 wherein the sapphire tube is bonded to the optic fiber using an interference fit between the sapphire tube and the optic fiber.

13. The article of manufacture of claim 1 wherein the sapphire tube is bonded to the optic fiber using a solder connection.

14. (canceled)

15. (canceled)

16. An article of manufacture, the article comprising:
an optic fiber comprising a core and a cladding surrounding the core;
a sapphire rod, fused to the core of the optic fiber and having a total internal reflection surface; and
a glass coating on the exterior surface of portions of the sapphire rod such that the glass coating defines an opening that exposes portions of the sapphire rod where light exits the sapphire rod after reflecting off the total internal reflection surface.

17. The article of manufacture of claim 16 further comprising an optic fiber piece having a first end fused to the glass coated total internal reflection surface of the sapphire rod.

18. The article of manufacture of claim 17 wherein the second end of the optic fiber piece is rounded.

19. A method comprising:
inserting an optic fiber into an interior of a sapphire tube;
bonding the optic fiber to the sapphire tube;
forming a total internal reflection surface after bonding the optic fiber to the sapphire tube such that light guided by the optic fiber reflects off the total internal reflection surface and out through the sapphire tube.

20. (canceled)

21. The method of claim 19 further comprising forming the total internal reflection surface on an end of the optic fiber.

22. (canceled)

23. (canceled)

24. The method of claim 19 wherein forming the total internal reflection surface comprises polishing the optic fiber and the sapphire tube.

25. The method of claim 24 further comprising fusing a glass rod to the total internal reflection surface.

26. The method of claim 19 further comprising fusing a coreless rod to the end of the optic fiber before inserting the optic fiber in the sapphire tube.

27. The method of claim 26 further comprising forming the total internal reflection surface on an end of the coreless rod.

28. (canceled)

29. (canceled)

30. The method of claim 26 wherein forming the total internal reflection surface comprises polishing the coreless rod and the sapphire tube.

31. The method of claim 30 further comprising fusing a glass rod to the total internal reflection surface.

32. (canceled)

33. A method comprising:
forming a total internal reflection surface on a sapphire rod;
forming a glass layer on the exterior of the sapphire rod such that an opening in the glass layer is present; and
bonding the sapphire rod to an optic fiber.

34. The method of claim 33 wherein forming a glass layer comprises:
applying a mask to a portion of an exterior surface of the sapphire rod;
coating the exterior surface of the sapphire rod and the mask with glass; and
removing the mask and glass over the mask.

35. The method of claim 33 further comprising bonding a rounded optic fiber piece to the glass layer that extends over the total internal reflection surface.

36. A method comprising:
filling a sapphire tube with molten glass;
cooling the glass-filled sapphire tube;
forming a total internal reflection surface on the glass-filled sapphire tube; and
bonding the glass-filled sapphire tube to an optic fiber.

37. The method of claim 36 wherein filling the sapphire tube with molten glass comprises dipping a portion of the sapphire tube in molten glass.

38. The method of claim 36 further comprising bonding a rounded glass rod to the total internal reflection surface.

39. The method of claim 34 further comprising polishing an end of the glass-filled sapphire tube opposite the total internal reflection surface to form a polished end and wherein bonding the glass-filled sapphire tube to the optic fiber comprises bonding the polished end to the optic fiber.
